(19) United States
(12) Patent Application Publication
(10) Pub. No.: US 2021/0187638 A1
(43) Pub. Date: Jun. 24, 2021

(54) PORTABLE SAW WITH CIRCULAR BLADE

(71) Applicants: Frank Welborn, Satsuma, FL (US); Albert Renz, Northport, NY (US)

(72) Inventor: Frank Welborn, Satsuma, FL (US)

(21) Appl. No.: 16/722,404

(22) Filed: Dec. 20, 2019

(51) Int. Cl. B23D 61/02; B27B 33/10; B27B 33/08; B27B 27/00

(52) U.S. Cl. CPC B23D 61/02; B27B 27/00; B27B 33/08; B27B 33/10

(57) ABSTRACT

A single-hand operable portable hand-held saw, including a handle portion with a motor. The motor is operably connected to one or more drive gears positioned on an interior side of a protective cover. One or more idle gears are positioned on an interior side of the protective cover. The idle gears and the drive gears are operatively coupled with and rotatably engaged with an annular saw blade. A throat opening in the protective cover is positioned adjacent a stop guide for stabilizing the saw against a material during cutting operations.

### TECHNICAL FIELD

The present invention generally relates to portable saws, and more particularly to a portable band saw with a circular blade.

### BACKGROUND

Vertical band saws were traditionally the tool of choice for cutting conduit, pipe and a variety of other materials. However, the size of such saws makes it difficult to easily transport vertical band saws to the job site. As a result, portable band saws were designed for use on the job site by electricians, steel workers, pipe fitters, etc. The conventional portable band saw design is still a substantial piece of equipment and requires two-handed operation to support the saw above the work piece. As a result of the two-handed operation and the weight of the tool, operators often must stand in awkward, physically detrimental, and potentially dangerous positions to make the appropriate cut. The manner in which the saw needs to be manipulated requires the work piece be fixed in some manner such as by clamp or vise. This process is sometimes cumbersome because of the length or weight of the stock and also results in lower back injuries because of the awkward posture in making the cut. Furthermore, the size of the stock that can be cut with conventional portable band saws is significantly limited by the shallow depth of the “throat” area in the cutting area between ends of conventional portable band saws.

Examples of deficiencies of conventional portable band saws include at least requiring two hand operation, heavy weight, line of sight issues (e.g., difficult to follow cutting guide markings), difficult blade changing, difficult cut control, and a limited throat depth. Similarly, conventional reciprocating saws include several deficiencies, including, for example, at least requiring two hand operation, heavy weight, kick back issues, and difficult cut control. The present invention advantageously solves all of the above-mentioned deficiencies present in conventional portable saws (e.g., portable band saw, reciprocating saw, etc.).

### SUMMARY

In accordance with an aspect of the present invention, a single-hand operable portable hand-held saw, including a handle portion with a motor is provided. The motor is operably connected to one or more drive gears positioned on an interior side of a protective cover. One or more idle gears are positioned on an interior side of the protective cover. The idle gears and the drive gears are operatively coupled with and rotatably engaged with an annular saw blade. A throat opening in the protective cover is positioned adjacent a stop guide for stabilizing the saw against a material during cutting operations.

In accordance with another aspect of the present invention, a saw blade is provided. The saw blade includes an annular blade portion, a plurality of gear teeth disposed on an interior edge of the annular blade portion, and a plurality of saw teeth disposed on an exterior edge of the annular blade portion.

In accordance with another aspect of the present invention, a single-hand operable portable hand-held saw, including a separable blade assembly portion and separable handle portion with a motor is provided. The motor is operably connected to one or more drive gears positioned on an interior side of a protective cover of the separable blade assembly portion. One or more idle gears are positioned on an interior side of the protective cover. The idle gears and the drive gears are operatively coupled with and rotatably engaged with an annular saw blade. A throat opening in the protective cover is positioned adjacent a stop guide for stabilizing the saw against a material during cutting operations.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram showing a side view of a portable saw device with a circular blade and a protective cover with a locking mechanism, in accordance with an embodiment of the present invention;

FIG. 2 is a diagram showing a cross-sectional view showing a portable saw device with a circular blade, in accordance with an embodiment of the present invention;

FIG. 3 is a diagram showing a side view of a portable saw device with a circular blade and an open protective cover including a locking mechanism, in accordance with an embodiment of the present invention;

FIG. 4 is a diagram showing a side view of a portable saw with no blade attached and an open protective cover including a locking mechanism, in accordance with an embodiment of the present invention;

FIG. 5 is a diagram showing a side view of a portable saw device with a separable handle and blade assembly, in accordance with an embodiment of the present invention;

FIG. 6 is a diagram showing a perspective view of a circular saw blade for attachment to a portable saw device, in accordance with an embodiment of the present invention; and

FIG. 7 is a diagram showing a perspective view of a motor and connection assembly for separable parts of the portable saw device of FIG. 5, in accordance with an embodiment of the present invention.

### DETAILED DESCRIPTION

In accordance with various embodiments of the present invention, a single-hand operable portable band saw with a substantially circular blade and stop guide is provided such that the band saw can be comfortably held with a single hand while the other hand is free to, for example, control the stock being cut rather than requiring the stock (e.g., material to be cut) to be secured (e.g., using a vise, clamps, etc.).

Exemplary applications/uses to which the present invention can be applied include, but are not limited to cutting any of a plurality of materials, including, for example, metal piping, polyvinyl chloride (PVC) piping, iron piping, wood, braces, flat stock, cast iron, forming tenons, tree limbs, stair rails, forming notches, compound miter cuts, decorative ends and corbels, etc., in accordance with embodiments of the present invention. The present invention provides a user a lightweight and portable saw for single-handed cutting operation such that the stock can be placed in contact with the stop guide during cutting to naturally orient the cutting section of the blade in a plane normal to the stock to make a precision clean cut. The stop guide/fence further can be a safety feature serving as a barrier between the hand of a user and the saw blade. The stop guide/fence can support the stock and aid in making an accurate cut.

In some embodiments of the present invention, a single-hand operable band saw with a circular saw blade can include a frame or chassis assembly and a drive shaft, drive chain, axle, etc. type assembly disposed within a portion of the frame, handle, or chassis assembly and connected to a driven gear for allowing the driven gear to move relative to the drive gear(s). In some embodiments, a single-hand operable band saw includes a frame or chassis assembly and a cam assembly (e.g., camshaft) disposed within a portion of the frame, handle, or chassis assembly and connected to a driven gear for allowing the driven gear to move relative to the drive gear, and the drive gear is configured to attach to teeth on an inside edge of a substantially circular blade to turn the blade at any of a plurality of selectable speeds, and/or change blade rotation direction. In some embodiments, the blade assembly is removable from the handle portion and differently sized blades/blade assemblies (e.g., 8-inch diameter blade, 12-inch diameter blade, etc.) can be interchangeably attached to the handle portion using a universal connector (e.g., snap connection, twist connection, clip connection, etc.). Moreover, appropriate gearing reduction is provided between the motor and the drive gear to control the maximum rotation of the cutting blade.

In another embodiment of the present invention, a method for operating a single-hand operable hand-held portable band saw with a substantially circular blade and stop guide is provided, including grasping the band saw by a handle extending at an acute angle from a longitudinal edge of the saw frame, orienting a work piece to be cut by the saw, resting the work piece against a stop guide/fence extending from a frame of the saw, and engaging the motor (e.g., battery powered, plug-in, gasoline powered, etc.) of the saw to cause the blade to cut through the work piece along a path selected by a user.

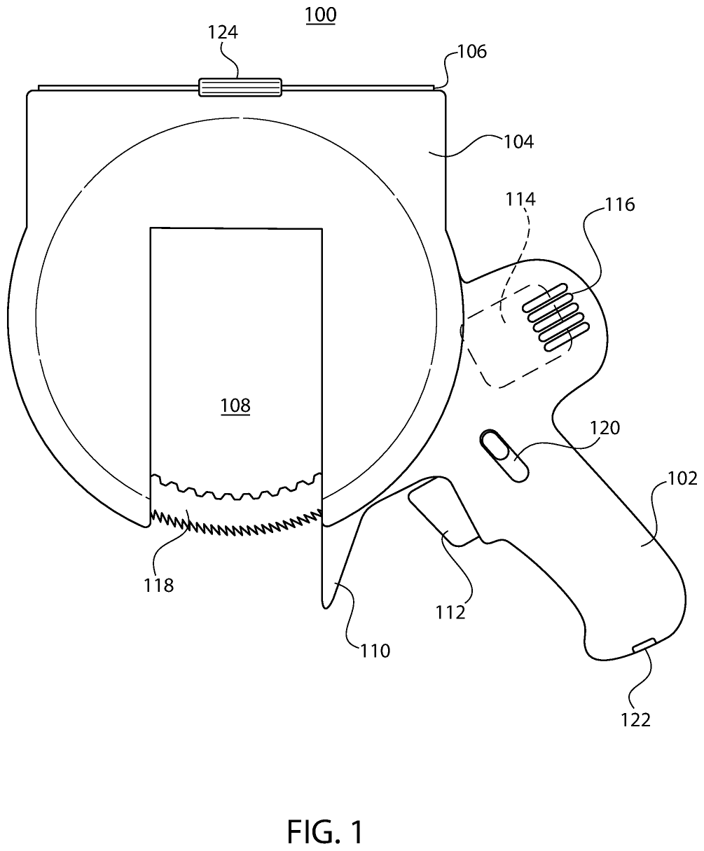

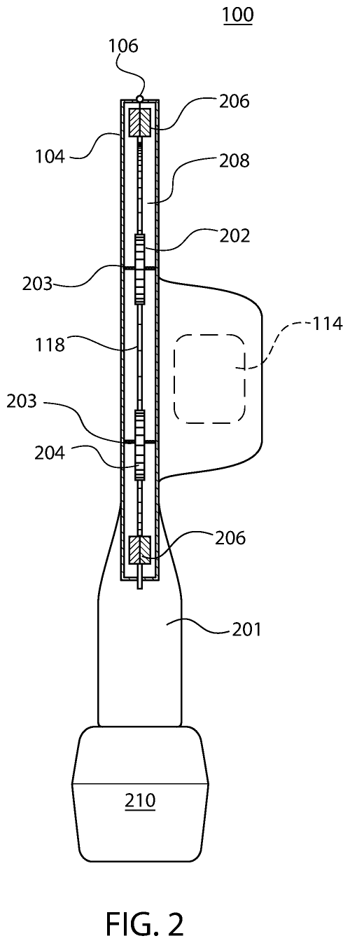

Referring now to the drawings in which like numerals represent the same or similar elements and initially to FIG. 1, a side view of a portable saw device 100 including an attached substantially circular blade 118 and a protective cover 104 with a locking mechanism 124 is illustratively depicted in accordance with an embodiment of the present invention. In various embodiments of the present invention, the blade 118 can be circular and can include a center cutout portion of a larger planar width than the remaining portion of the blade, and it is to be appreciated that different blade to center cutout portion ratios can be employed in accordance with various embodiments of the present invention. In some embodiments, the portable saw device 100 can include a handle portion 102, which can include a power port/charging port 122 (e.g., USB, AC, etc.) and a non-removable internal rechargeable battery (not shown) or a removable rechargeable battery, as described herein below with reference to element 210 of FIG. 2. The removable battery pack 210 can include a built-in power port/charging port (not shown) or the battery pack 210 can be placed in a charging station (e.g., charging cradle) after removal from the saw 100 for recharging. In some embodiments, the saw 100 can be a corded, plug-in device without a battery pack or internal battery.

A speed selector 120 (e.g., switch, wheel, dial, touch-screen, etc.) can be positioned on the handle portion 102 such that the speed selector 120 is easily accessible for a user to select any of a plurality of speeds during single-handed operation of the saw 100. The speed of the saw blade 118 can be adjusted for cutting any of a plurality of types of materials (e.g., steel piping, tree branches, staircase railings, etc.) efficiently and accurately. The handle portion can include a trigger 112 (e.g., button, switch, touch screen, etc.) for engaging a motor 114. The motor 114 can be operatively coupled to the saw blade 118 to provide rotation for the saw blade 118 for cutting operations, and can include a vent 116 for temperature regulation of the saw 100.

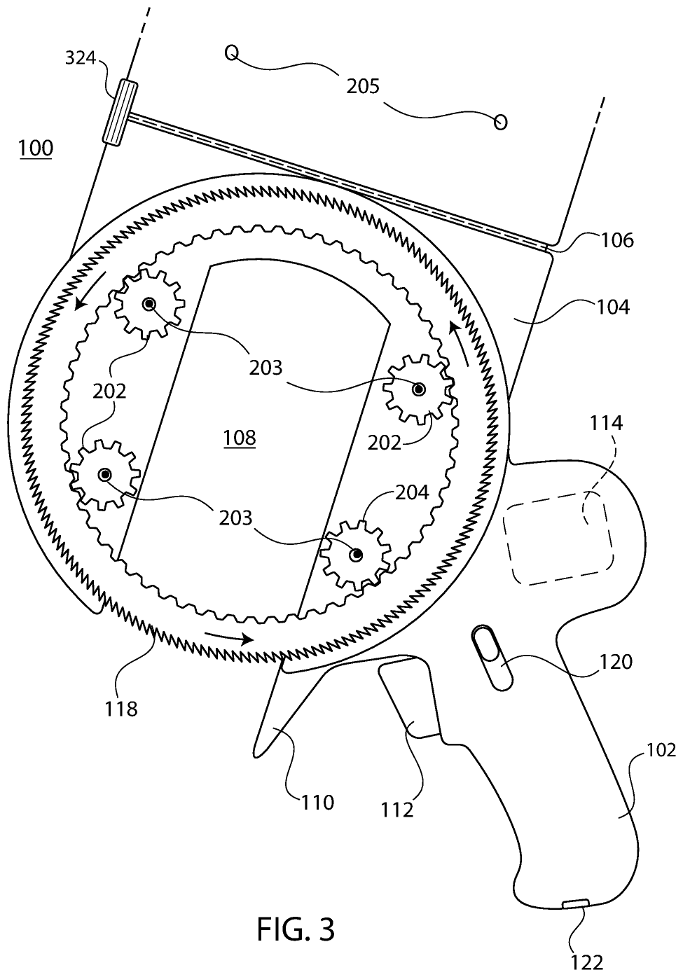

In some embodiments, the saw 100 can include a blade assembly protective cover 104, which can include two substantially similar portions functionally connected by a hinge mechanism 106 for opening the cover 104 to expose the saw blade 118 (e.g., to change blade, remove debris, etc.) and the gears 202, 204, described in further detail herein below with reference to FIG. 3. The protective cover 104 can include a cutout throat portion 108 which provides a deep clearance space for cutting material using the blade 118. The protective cover 104 can be secured in a closed state using any appropriate locking mechanism 124 (e.g., clip, snap, slider, etc.) in accordance with various embodiments of the present invention. A stop guide/fence 110 can be positioned with an edge along the edge of the throat portion 108 of the protective cover 104, and can be utilized by pushing the stop guide 110 against the material being cut during cutting operations to provide stability and a precision cut during single-handed cutting using the saw, thereby freeing up a user's other hand to, for example, hold the material being cut without the use of a vise or other securing mechanism. It is to be appreciated that the plurality of components of the saw device 100 can be formed from any appropriate materials, including, for example, forged metal, plastic, PVC, glass, alloys, cast metal, diamond blade, carbon tip, etc. in accordance with various embodiments of the present invention.

Referring now to FIG. 2, a cross-sectional view of a portable saw device 100 including a circular blade 118 is illustratively depicted in accordance with an embodiment of the present invention. In some embodiments, the portable saw device 100 can include a handle portion 201, which can include a removable rechargeable battery pack 210. The removable battery pack 210 can include a built-in power port/charging port (not shown) or the battery pack 210 can be placed in a charging station (e.g., charging cradle) after removal from the saw 100 for recharging. In some embodiments, the saw 100 can be a corded, plug-in device without a battery pack 210 or internal battery.

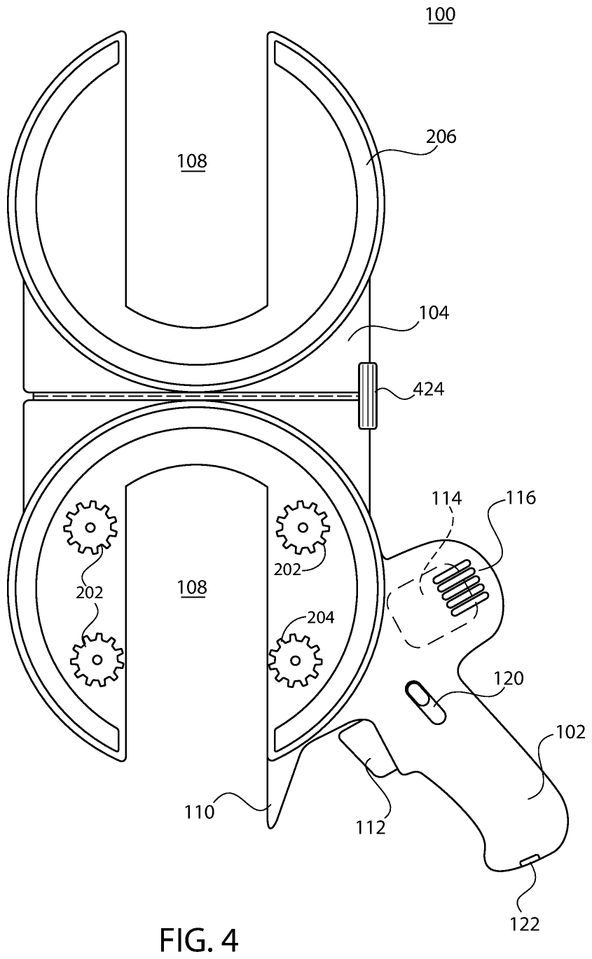

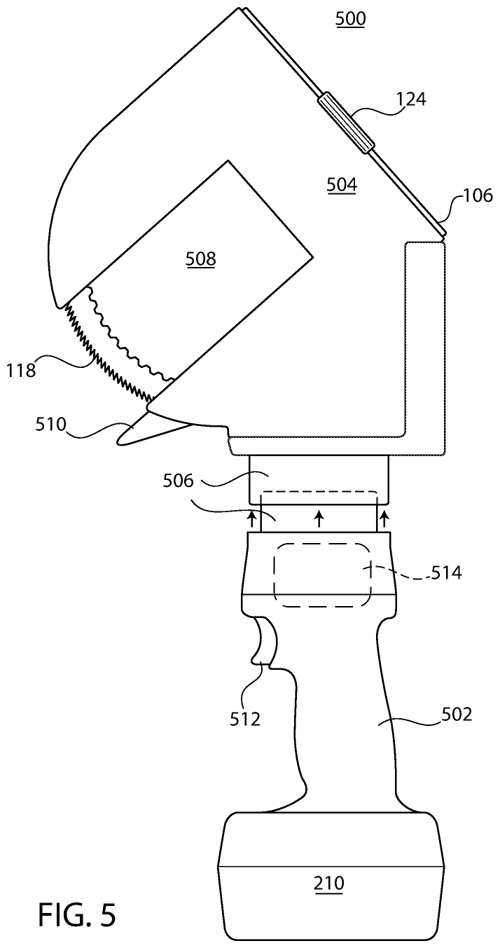

In some embodiments, a motor 114 can be operatively coupled to the saw blade 118 to provide rotation for the saw blade 118 for cutting operations, and can be positioned in any of a plurality of positions including, for example, connected on a side of a blade assembly 104 of the saw 100 (as shown in FIG. 2) or within the handle. The motor 114 can be directly operatively linked (e.g., gears seated together, drive sprocket, etc.) to a drive gear 204, and the drive gear 204 can be operatively coupled for cutting operations to the blade 118 and protective cover 104 using any appropriate connector 203 (e.g., pin (e.g., cotter pin, clevis pin, threaded rod, bearings, etc.), drive sprocket, clip, etc.), and connector receiver, as described in further detail with reference to element 205 of FIG. 3 herein below. The protective cover 104 can be secured in a closed state using any appropriate locking mechanism (e.g., clip, snap, slider, etc.), as shown by element 124 of FIGS. 1 and 5, element 324 of FIG. 3, and element 424 of FIG. 4, in accordance with various embodiments of the present invention. It is to be appreciated that although the embodiments showing locking mechanisms 124, 324, and 424 are particularly placed and are of a particular type for simplicity of illustration, any of a plurality of types of locking mechanism placement and/or types of locking mechanisms can be employed in accordance with various embodiments of the present invention. The drive gear 204 can be configured to rotate the blade 118 toward the stop guide 110 to pull the material to be cut and the blade toward the stop guide 110, but it is to be appreciated that the saw 100 can include a reverse function in which the blade 118 can rotate in the opposite direction in accordance with various embodiments of the present invention. The protective cover 104 can be opened for access to the blade 118, gears 202, 204, etc. using a hinge 106.

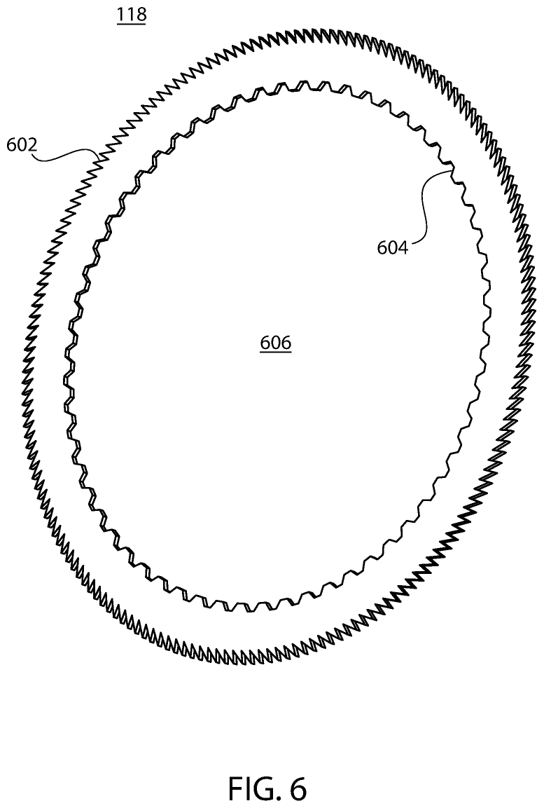

In some embodiments, one or more idle gears 202 can be utilized to provide tension on the blade 118 and/or to push/pull the blade 118 away or toward the drive gear for stabilization of the blade 118 for precision cuts during cutting operations. The gears can be positioned within a gear shaft 208 (e.g., positioned to be operably connected to the motor for providing rotation to the blade 118), and one or more blade wear/stabilization guides 206 can be positioned on the interior side of the protective cover 104. The blade wear/stabilization guides 206 can be sized to be equal to, or more narrow than the width of the blade 118 between the blade teeth 602 and the gear teeth 604 (described in further detail with reference to FIG. 6 herein below) such that the blade wear/stabilization guide 206 prevents the blade 118 and/or gears/sprockets 202, 204 from contacting the protective cover 104 during use.

In some embodiments, the blade wear/stabilization guides 206 can include blade guide adjustors (not shown) for adjusting the distance between respective blade wear/stabilization guides 206 and the saw blade 118 to, for example, enable user customization for saw blades of different thicknesses, reduce rubbing of the blade 118 against the blade wear/stabilization guide 206, increase stabilization of the blade 118 by reducing the space between the blade 118 and the blade wear/stabilization guide 206, etc. In some embodiments, the blade wear/stabilization guide 206 is fixed and optimally positioned for a saw blade 118 of a pre-determined thickness (e.g., ⅛-inch, 1/16 inch, etc.), depending on the particular desired cutting operation and/or blade type.

Referring now to FIG. 3, a side view of a portable saw device 100 with a circular blade 118 and an open protective cover 104 including a locking mechanism 324 is illustratively depicted in accordance with an embodiment of the present invention. In some embodiments, the portable saw device 100 can include a handle portion 102, which can include a power port/charging port 122 (e.g., USB, AC, etc.) and a non-removable internal rechargeable battery (not shown) or a removable rechargeable battery, as described above with reference to element 210 of FIG. 2. The removable battery pack 210 can include a built-in power port/charging port (not shown) or the battery pack 210 can be placed in a charging station (e.g., charging cradle) after removal from the saw 100 for recharging. In some embodiments, the saw 100 can be a corded, plug-in device without a battery pack or internal battery.

A speed selector 120 (e.g., switch, wheel, dial, touch-screen, etc.) can be positioned on the handle portion 102 such that the speed selector 120 is easily accessible for a user to select any of a plurality of speeds during single-handed operation of the saw 100. The speed of the saw blade 118 can be adjusted for cutting any of a plurality of types of materials (e.g., steel piping, tree branches, staircase railings, etc.) efficiently and accurately. The handle portion 102 can include a trigger 112 (e.g., button, switch, touch screen, etc.) for engaging a motor 114. The motor 114 can be operatively coupled to the saw blade 118 to provide rotation for the saw blade 118 for cutting operations.

In some embodiments, the motor 114 can be operatively coupled to the saw blade 118 to provide rotation for the saw blade 118 for cutting operations, and can be positioned in any of a plurality of positions including, for example, connected on a side of a blade assembly 104 of the saw 100 (as shown in FIG. 2) or within the handle 102. The motor 114 can be directly operatively linked (e.g., gears seated together, drive sprocket, etc.) to a drive gear 204, and the drive gear 204 can be operatively coupled for cutting operations to the blade 118 and secured to the protective cover 104 using any appropriate connector 203 (e.g., pin (e.g., cotter pin, clevis pin, threaded rod, bearings, etc.), drive sprocket, clip, etc.) and attachment point/mechanism 205 (e.g., pinhole, clamp, threaded rod receiver, bearing receiver, etc.) in accordance with various embodiments of the present invention. The protective cover 104 can be secured in a closed state using any appropriate locking mechanism 324 (e.g., clip, snap, slider, etc.) in accordance with various embodiments of the present invention. The drive gear 204 can be configured to rotate the blade 118 toward the stop guide 110 to pull the material to be cut and the blade toward the stop guide 110, but it is to be appreciated that the saw 100 can include a reverse function in which the blade 118 can rotate in the opposite direction in accordance with various embodiments of the present invention. The protective cover 104 can be opened for access to the blade 118, gears 202, 204, etc. using a hinge 106. One or more idle gears 202 can be utilized to provide tension on the blade 118 and/or to push/pull the blade 118 away or toward the drive gear 204 for stabilization of the blade 118 for precision cuts during cutting operations.

In some embodiments, the saw 100 can include a blade assembly protective cover 104, which can include two substantially similar portions functionally connected by a hinge mechanism 106 for opening the cover 104 to expose the saw blade 118 (e.g., to change blade, remove debris, etc.) and the gears 202, 204 for user access. The protective cover 104 can include a cutout throat portion 108 which provides a deep clearance space for cutting material using the blade 118. A stop guide/fence 110 can be positioned with an edge along the edge of the throat portion 108 of the protective cover 104, and can be utilized by pushing the stop guide 110 against the material being cut during cutting operations to provide stability and a precision cut during single-handed cutting using the saw, thereby freeing up a user's other hand for other tasks, including, for example, holding the material being cut with the user's free hand (e.g., without the use of a vise or other securing mechanism). It is to be appreciated that the plurality of components of the saw device 100 can be formed from any appropriate materials, including, for example, forged metal, plastic, PVC, glass, alloys, cast metal, etc. in accordance with various embodiments of the present invention.

Referring now to FIG. 4, a side view of a portable saw device 100 with no blade attached and an open protective cover 104 including a locking mechanism 424 is illustratively depicted in accordance with an embodiment of the present invention. In some embodiments, the portable saw device 100 can include a handle portion 102, which can include a power port/charging port 122 (e.g., USB, AC, etc.) and a non-removable internal rechargeable battery (not shown) or a removable rechargeable battery, as described above with reference to element 210 of FIG. 2. The removable battery pack 210 can include a built-in power port/charging port (not shown) or the battery pack 210 can be placed in a charging station (e.g., charging cradle) after removal from the saw 100 for recharging. In some embodiments, the saw 100 can be a corded, plug-in device without a battery pack or internal battery.

A speed selector 120 (e.g., switch, wheel, dial, touch-screen, etc.) can be positioned on the handle portion 102 such that the speed selector 120 is easily accessible for a user to select any of a plurality of speeds during single-handed operation of the saw 100. The speed of the rotation of the drive gear 204 can be adjusted for cutting any of a plurality of types of materials (e.g., steel piping, tree branches, staircase railings, etc.) efficiently and accurately. The handle portion can include a trigger 112 (e.g., button, switch, touch screen, etc.) for engaging a motor 114. The motor 114 can be operatively coupled to the drive gear 204 for rotating a saw blade 118, as described above with reference to FIG. 1, for cutting operations, and can include a vent 116 for temperature regulation of the saw 100 during use.

The motor 114 can be positioned in any of a plurality of positions including, for example, connected on a side of a blade assembly 104 of the saw 100 (as shown in FIG. 2) or within the handle 102. The motor 114 can be directly operatively linked (e.g., gears seated together, drive sprocket, etc.) to a drive gear 204, and the drive gear 204 can be operatively coupled for cutting operations to the blade 118 of FIG. 1, and secured to the protective cover 104 using any appropriate connector (e.g., pin, drive sprocket, clip etc.), as described in further detail with reference to elements 203 and 205 of FIG. 3, and the protective cover 104 can be secured in a closed state using any appropriate locking mechanism 424 (e.g., clip, snap, slider, etc.) in accordance with various embodiments of the present invention.

The drive gear 204 can be configured to rotate the blade 118 of FIG. 1 toward the stop guide 110 to pull the material to be cut and the blade toward the stop guide 110, but it is to be appreciated that the saw 100 can include a reverse function in which the blade 118 of FIG. 1 can rotate in the opposite direction in accordance with various embodiments of the present invention. One or more idle gears 202 can be utilized to provide tension on the blade 118 of FIG. 1 and/or to push/pull the blade 118 of FIG. 1 away or toward the drive gear 204 for stabilization of the blade 118 of FIG. 1 for precision cuts during cutting operations.

In some embodiments, the saw 100 can include a blade assembly protective cover 104, which can include two substantially similar portions functionally connected by a hinge mechanism 106 for opening the cover 104 to expose a saw blade (e.g., element 118 of FIG. 1) and the gears 202, 204 for user access to, for example, change blades, remove debris, etc. The protective cover 104 can include a cutout throat portion 108 which provides a deep clearance space for cutting material. A stop guide/fence 110 can be positioned with an edge along the edge of the throat portion 108 of the protective cover 104, and can be utilized by pushing the stop guide 110 against the material being cut during cutting operations to provide stability and a precision cut during single-handed cutting using the saw, thereby freeing up a user's other hand to, for example, hold the material being cut without the use of a vise or other securing mechanism.

In some embodiments, one or more blade wear/stabilization guides 206 can be positioned on the interior side of the protective cover 104. The blade wear/stabilization guides 206 can be sized to be equal to, or more narrow than the width of the blade (e.g., element 118 of FIG. 1) between the blade teeth 602 and the gear teeth 604 (described in further detail with reference to FIG. 6 herein below) such that the blade wear/stabilization guide 206 prevents the blade 118 and/or gears/sprockets 202, 204 from contacting the protective cover 104 during use. However, it is to be appreciated that the blade wear/stabilization guides 106 can be of any size and/or configuration which sufficiently functions as a blade wear/stabilization guide in accordance with various embodiments of the present invention.

In some embodiments, blade wear/stabilization guides 206 can include blade guide adjustors (not shown) for adjusting the distance between respective blade wear/stabilization guides 206 and the saw blade (e.g., element 118 of FIG. 1) to, for example, enable user customization for saw blades of different thicknesses, reduce rubbing of the blade (e.g., element 118 of FIG. 1) against the blade wear/stabilization guides 206, increase stabilization of the blade (e.g., element 118 of FIG. 1) by reducing the space between the blade (e.g., element 118 of FIG. 1) and the blade wear/stabilization guides 206, etc. In some embodiments, the blade wear/stabilization guides 206 can be fixed and optimally positioned for a saw blade (e.g., element 118 of FIG. 1) of a pre-determined thickness (e.g., ⅛-inch, 1/16 inch, etc.), depending on the particular desired cutting operation and/or blade type. The blade wear/stabilization guides 206 can include indicators (e.g., color change, indentations, etc.) that alert a user to replace the worn blade wear/stabilization guides 206 for optimal functionality of the saw 100.

Referring now to FIG. 5, a side view of a portable saw device 500 with a separable handle 502 and blade assembly 504 is illustratively depicted in accordance with an embodiment of the present invention. In some embodiments, the saw device 500 can include similar features as the saw device of, FIG. 1, including, for example, a handle 502, a triggering device 512, a removable rechargeable battery pack 210, a stop guide/fence 510, a throat portion 508, and a protective cover 504 configured for securing a substantially circular saw blade 118 and one or more gears (e.g., 202 and 204 of FIG. 4). The protective cover 504 can be secured in a closed state using any appropriate locking mechanism 124 (e.g., clip, snap, slider, etc.) in accordance with various embodiments of the present invention. The gears (e.g., 202 and 204 of FIG. 4) can be operatively connected to a motor 514 using the connector portions 506 to provide rotational force to the saw blade 118 during use. It is to be appreciated that the saw device 500 of FIG. 5 can include one or more features of the saw device 100 of FIGS. 1, 2, 3, and 4, and the saw device 100 of FIGS. 1, 2, 3, and 4 can similarly include one or more features described with respect to the saw device 500 of FIG. 5, in accordance with various embodiments of the present invention.

Referring now to FIG. 6, a perspective view of a circular saw blade for attachment to a portable saw device is illustratively depicted in accordance with an embodiment of the present invention. In some embodiments of the present invention, a substantially circular (e.g., annular) saw blade 118 includes saw teeth 602 positioned on an outer circumference edge and gear teeth 604 on an inner circumference edge of the saw blade 118. The gear teeth 604 can be seated and operatively coupled to one or more gears (e.g., 202, 204 of FIG. 3) such that the one or more gears (e.g., drive gear 204 of FIG. 3) can apply rotational force to the gear teeth 604 of the saw blade 118 to provide sufficient rotational torque to the saw blade 118 for cutting operations at any of a plurality of selectable blade rotation speeds. The idle gears (e.g., element 202 of FIG. 3) can be seated and operatively coupled to the gear teeth 604 for stabilization, precision cutting, etc. in accordance with embodiments of the present invention. The saw teeth 602 can be configured such that the saw blade 118 rotates toward a stop guide (e.g., element 110 of FIG. 1) during cutting operations. In some embodiments, the saw blade 118 can include a cutout portion 606 with the edge of the cutout portion 606 including the gear teeth 604. The cutout portion 606 can be sized such that the diameter of the cutout portion is significantly larger (e.g., 10/1 ratio, 5/1 ratio, etc.) than the planar width of the blade between the saw teeth 602 and the gear teeth 604. However, it is contemplated that other blade sizing configurations can be utilized dependent on placement of gears (e.g., 202, 204 of FIG. 3) and/or to accommodate different blade sizes in accordance with various embodiments of the present invention. An exemplary embodiment including, for example, a 10-inch diameter saw blade 118 can include a substantially circular cutout portion 606 with a diameter of 6 inches with a planar width of the blade between opposing sides (e.g., between the saw teeth 602 and the gear teeth 604) being 2 inches. The saw blade 118 can be formed from any appropriate saw materials, including, for example, metals, alloys, molded plastic, abrasive discs, etc.), and can include any of a plurality of teeth per inch (TPI) of the saw teeth 602 (e.g., for precise cutting of any of a plurality of different types of materials) or the gear teeth 604 (e.g., for different gear configuration embodiments), in accordance with various embodiments of the present invention.

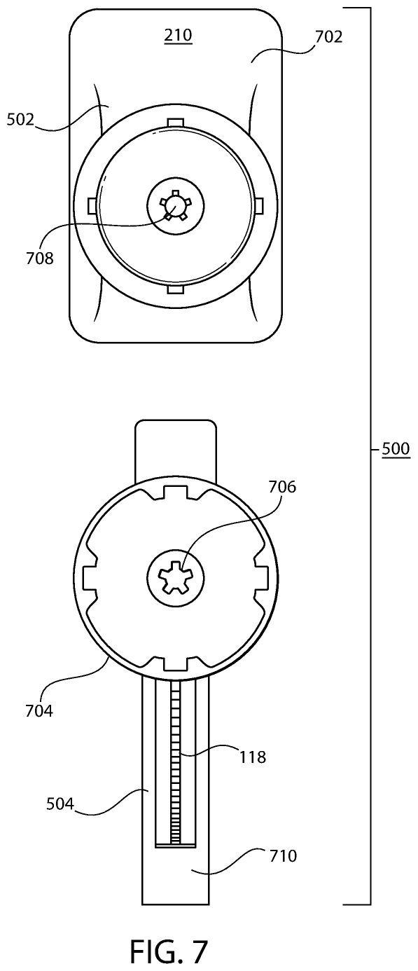

Referring now to FIG. 7, a perspective view of a motor and connection (e.g., motor/gear connection) assembly for operably connecting separable parts of the portable saw device 500 of FIG. 5 for sawing operations is illustratively depicted in accordance with an embodiment of the present invention. In some embodiments, the saw device 500 can include a base portion 702 and a blade assembly portion 710. The base portion 702 can include a removable rechargeable battery pack 210 connectable to a handle 502 for powering the saw 500 during use. The base portion can include a motor with a powered connector gear 708 for providing rotational force/torque during use of the saw 500. The blade assembly portion 710 can include a protective cover 504, a blade 118, and a receiver connector gear 706 operably attached to the powered connector gear 708 to provide rotational force/torque during use of the saw 500. A locking mechanism 704 can secure the base portion 702 and the blade assembly portion 710 to engage the powered connector gear 708 and the receiver connector gear 706 to prepare the saw device 510 for use in accordance with various embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of this disclosure.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A single-hand operable portable hand-held saw, comprising:
a handle having a motor, one or more drive gears operably connected to the motor, and a protective blade cover having an interior side and an exterior side, the drive gears being positioned on the interior side of the protective cover;
one or more idle gears positioned on the interior side of the protective cover;
an annular saw blade positioned within the protective cover and rotatably engaged with both the drive gears and the idle gears; and
a throat opening in the protective cover configured to expose a cutting edge of the blade and allow for a predetermined depth of cutting.

2. The portable hand-held saw of claim 1, further comprising a stop guide positioned adjacent the throat opening and configured to stabilize the saw against a material during cutting operations.

3. The portable hand-held saw of claim 1, wherein the annular saw blade includes a plurality of gear teeth along an interior edge of the saw blade.

4. The portable hand-held saw of claim 1, wherein the annular saw blade includes a plurality of saw teeth along an exterior edge of the saw blade.

5. The portable hand-held saw of claim 2, wherein the idle gears and the drive gears are configured to couple with the annular blade by positioning the gear teeth of the annular blade with corresponding gear teeth of the idle gears and the drive gears.

6. The portable hand-held saw of claim 4, wherein the gear teeth of the idle gears and drive gears include centered pinholes corresponding to pinholes in the protective cover configured for securing the drive gears, the idle gears, and the annular blade to the protective cover.

7. The portable hand-held saw of claim 6, further comprising one or more cotter pins configured to be inserted through the protective cover pinholes, the drive gear pinholes, and the idle gear pinholes when the protective cover is in a closed position.

8. The portable hand-held saw of claim 1, further comprising a locking mechanism configured to securely lock the protective cover closed during cutting operations.

9. The portable hand-held saw of claim 1, further comprising one or more stabilization guides positioned on an interior side of the protective cover, the stabilization guides being sized equal to or more narrow than the planar width of the annular saw blade.

10. The portable hand-held saw of claim 9, wherein the stabilization guides are adjustable to accommodate blades of different thicknesses by increasing a size of a space between the saw blade and the stabilization guide, and to increase stabilization of the blade by reducing a space between the saw blade and the stabilization guide.

11. A saw blade, comprising:
an annular blade having an interior edge and an exterior edge;
a plurality of gear teeth disposed on the interior edge; and
a plurality of saw teeth disposed on an exterior edge.

12. The saw blade of claim 11, wherein the saw blade is configured to be operatively coupled to a portable saw.

13. The saw blade of claim 12, wherein the saw blade is configured to be operatively coupled to the portable saw by positioning the gear teeth of the annular blade with corresponding gear teeth of idle gears and drive gears secured to an interior of a protective cover of the portable saw.

14. The saw blade of claim 11, wherein the saw blade is configured to be operatively coupled to a single-hand operable portable saw.

15. A single-hand operable portable hand-held saw, comprising:
a handle having a motor; and
a blade assembly having:
a protective cover configured to be releasably connected to the handle, the protective cover having an interior side and an exterior side, with drive gears and idle gears positioned on the interior side, the drive gears being selectively powered by the motor when the blade assembly is connected to the handle;
an annular saw blade positioned within the protective cover and engaged with the drive gears and the idle gears; and
a throat opening in the protective cover configured to expose a cutting edge of the blade and allow for a predetermined depth of cutting.

16. The portable hand-held saw of claim 15, further comprising a stop guide adjacent the throat opening and configured to stabilize the saw against a material during cutting operations.

17. The portable hand-held saw of claim 15, further comprising a coupling mechanism for operably connecting the separable blade assembly portion with the separable handle assembly portion.

18. The portable hand-held saw of claim 15, further comprising a removable rechargeable battery configured to be inserted into the separable handle portion.

19. The portable hand-held saw of claim 15, wherein the annular saw blade includes a plurality of gear teeth along an entire interior edge of the saw blade, and a plurality of saw teeth along the entire exterior edge of the saw blade.

20. The portable hand-held saw of claim 19, wherein the idle gears and the drive gears are configured to couple with the annular blade by positioning the gear teeth of the annular blade with corresponding gear teeth of the idle gears and the drive gears.
